(19) United States
(12) Patent Application Publication
(10) Pub. No.: US 2013/0079257 A1
(43) Pub. Date: Mar. 28, 2013

(54) DISPERSANT AND A DRILLING FLUID CONTAINING THE SAME

(71) Applicants: China Petroleum & Chemical Corporation, Beijing (CN); SINOPEC Research Institute of Petroleum Engine, Beijing (CN)

(72) Inventors: Yongxue Lin, Beijing (CN); Xiaohua Yang, Beijing (CN); Lin Wang, Beijing (CN); Lishan Cai, Beijing (CN); Xiaoqiang Dong, Beijing (CN); Long Chai, Beijing (CN)

(73) Assignees: SINOPEC Research Institute of Petroleum Engineering, Beijing (CN); China Petroleum & Chemical Corporation, Beijing (CN)

(21) Appl. No.: 13/628,017

(22) Filed: Sep. 26, 2012

(30) Foreign Application Priority Data
Sep. 28, 2011 (CN) 201110301295.2
Sep. 28, 2011 (CN) 201110301302.9

(51) Int. Cl. C09K 8/035; C09K 8/12; C09K 8/08

(52) U.S. Cl. 507/108

(57) ABSTRACT

The present invention provides a dispersant and a drilling fluid containing the dispersant. The dispersant comprises the product obtained from the reaction of water, lignin, phenol, sulfonating agent, telogen and catalyst at 140-220° C., preferably at 160-180° C.; the catalyst is one or more selected from the group consisting of sulfamic acid, p-toluenesulfonic acid and benzenesulfonic acid. The dispersant provided by the present invention not only can significantly lower the viscosity of the drilling fluid but also plays a role in reducing filtration loss.

### CROSS REFERENCE TO RELATED APPLICATIONS

This application claims priority to Chinese Application No. 201110301295.2, filed on Sep. 28, 2011 and entitled “A dispersant and the preparation and use thereof”; and claims priority to Chinese Application No. 201110301302.9, filed on Sep. 28, 2011 and entitled “A drilling fluid and the preparation and use thereof”, each of which is specifically and entirely incorporated by reference.

### FIELD OF THE INVENTION

The present invention relates to a dispersant and a drilling fluid containing the dispersant.

### BACKGROUND OF THE INVENTION

With the continuous deepening of oil and gas exploration at home and abroad, the drilled formations get more complex, and more deep wells and ultra-deep wells are drilled, and increasing attention is paid to the application of ulta-high density drilling fluid. Normally, large amounts of weighting materials are added in order to raise the density of the drilling fluid. However, this may seriously influence the performance of the drilling fluid. In a drilling fluid with a density of above 2.4 g/cm³ prepared with barite with a density of 4.2 g/cm³, the volume fraction of weighting materials is about 50% of the total volume of the drilling fluid. High solid content results in increase of internal friction, viscosity and yield point of the drilling fluid, worsening of shear thinning behavior and mud cake quality and vulnerability to pipe sticking.

The treatment agents having an effect of thinning and dispersion in a drilling fluid mainly fall into two categories. One category is modified natural polymers, such as: tannin alkaline liquor, tannin extract alkaline liquor, sulfomethylated tannin, ferric chomium lignin sulfonate and etc. They may be used to disperse a sodium bentonite drilling fluid. The thinners in this category feature broad sources and low price. Among them, tannin and tannin extract have a desirable thinning effect in fresh water sludge of shallow wells at low temperature. Ferric chomium lignin sulfonate is stable, but they contain chromium ions and pollute environment. The other category is synthetic polymers, such as polyacrylates and their derivatives X-40 series, zwitterionic polymers XY series and sulfonated styrene-maleic anhydride copolymer (SSMA) as well as the recently developed Si—F viscosity reducer SF-1 containing silicon and fluorine, and organic silicon thinner GX-1. They all play a good role in thinning dispersive-type sodium bentonite drilling fluid and polymer drilling fluid and reducing their viscosity, but the raw materials used are expensive and the product cost is high, which is not conducive to wide-range popularization and application.

The above thinning and dispersing agents show certain ability of thinning and viscosity reduction in application, particularly to water-based drilling fluid whose density is not very high. To some extent, they solve the problem that the viscosity and yield point of the drilling fluid go up in a deep well or at high temperature or after contamination. However, in a high-density drilling fluid, a ulta-high density drilling fluid in particular, these thinning and dispersing agents have a poor even no effect in reducing the viscosity and yield point for the following main reasons:

(1) The current thinning and dispersing agents in the category of modified natural polymers mainly act upon clay particles and are adsorbed to the edges of clay particles to raise the hydrating capacity of clay particles and weaken the edge-edge and edge-plane bonding among clay particles, thereby breaking up the structure formed by clay and lowering the viscosity and yield point of the drilling fluid.

(2) The thinning and dispersing agents in the category of synthetic polymers form stable complexes with macromolecular polymers and disassemble the structure formed by polymers to eliminate the viscosifying effect of polymers. In addition, the thinning and dispersing agents in the category of synthetic polymers can promote contraction and dehydration of macromolecular polymers, raise their adsorption capacity on clay particles and disassemble the structure formed by clay to lower the viscosity of the drilling fluid.

(3) Ulta-high density drilling fluid contains little clay. The increase of its viscosity and yield point is mainly caused by the friction between the solid particles of weighting agents and the interaction between solid particles and clay particles. A dispersing and viscosity reducing agent is needed to weaken the aggregation and friction among weighing agent particles, thereby evenly dispersing solid particles.

### SUMMARY OF THE INVENTION

The object of the present invention is to provide a dispersant with a desirable effect in reducing viscosity and a drilling fluid containing this dispersant to overcome the poor effect of the existing dispersant in reducing viscosity of the drilling fluid.

The present invention provides a dispersant comprising the product obtained from the reaction of water, lignin, phenol, sulfonating agent, telogen and catalyst at 140-220° C., preferably at 160-180° C.; the catalyst is one or more selected from the group consisting of sulfamic acid, p-toluenesulfonic acid and benzenesulfonic acid.

The present invention also provides a drilling fluid containing the foregoing dispersant.

The dispersant provided by the present invention can significantly lower the viscosity of the drilling fluid, possibly because the dispersant can promote the formation of a hydration shell with a certain thickness on the surface of barite and other solid weighting particles, thereby lessening the aggregation and friction among weighting agent particles, lowering the viscosity and yield point of the drilling fluid and improving fluidity. Further, the dispersant provided by the present invention also plays a role in reducing filtration loss.

According to a preferred embodiment of the present invention, when the filtration control agent in the drilling fluid contains the product obtained from the reaction of water, substance containing humic acid and/or modified humic acid, aldehyde and sulfonate polymer at 180-220° C., and the units containing sulfonate groups in the molecular chains of sulfonate polymer are at least 30 wt %, preferably 50-75 wt %, more preferably 60-75 wt %, and further the drilling fluid will have more excellent performance in reducing filtration loss and meet the requirements of the drilling of deep wells, ultra-deep wells and ultra high pressure formations.

Other characteristics and advantages of the present invention will be described in details in the subsequent embodiments.

### DETAILED DESCRIPTION OF THE EMBODIMENTS

Below the embodiments of the present invention are elaborated. It should be understood that the embodiments described here are only intended to describe and explain the present invention and not to limit it.

The present invention provides a dispersant comprising the product obtained from the reaction of water, lignin, phenol, sulfonating agent, telogen and catalyst at 140-220° C., preferably at 160-180° C.; the catalyst is one or more selected from the group consisting of sulfamic acid, p-toluenesulfonic acid and benzenesulfonic acid.

The reaction mechanism among the above substances may be as follows: lignin, phenol and telogen take reaction under the action of catalyst and with the existence of solvent water. Telogen mainly plays a role in bridging lignin and phenol and decides the molecular weight of the obtained product. The sulfonating agent raises the content of sulfonate groups in the product, thereby enhancing the dispersion effect and temperature or salt resistance of the dispersant.

According to the present invention, the dosages of water, lignin, phenol, sulfonating agent, telogen and catalyst may be selected and varied in a wide range and reasonably selected according to the design of dispersant. Typically, on the basis of 100 parts by weight of water, the dosage of the lignin may be 10-40 parts by weight, the dosage of the phenol may be 1.5-20 parts by weight, the dosage of the sulfonating agent may be 2.5-15 parts by weight, the dosage of the telogen may be 0.5-5 parts by weight and the dosage of the catalyst may be 0.5-4 parts by weight. Preferably, on the basis of 100 parts by weight of water, the dosage of the lignin is 15-30 parts by weight, the dosage of the phenol is 4-15 parts by weight, the dosage of the sulfonating agent is 5-10 parts by weight, the dosage of telogen is 1-4 parts by weight and the dosage of the catalyst is 0.8-2 parts by weight.

The present invention does not have special limitation to the types of lignin, phenol and sulfonating agent. They may be any lignin, phenol and sulfonating agent known to those skilled in the art. For example, the lignin may be herbal lignin or woody lignin. The phenol may be one or more selected from the group consisting of phenol, p-cresol and m-cresol. The sulfonating agent may be one or more selected from the group consisting of metal sulfite, metal hydrosulfite and sulfuric acid, wherein a concrete example of the metal sulfite may include without limitation: sodium sulfite and potassium sulfite, a concrete example of the metal hydrosulfite may include without limitation: sodium bisulfite and potassium bisulfite, and the sulfuric acid may be fuming sulfuric acid and/or 70-99.5 wt % concentrated sulfuric acid. Preferably, the sulfonating agent is one or more selected from the group consisting of sodium sulfite, sodium bisulfite and fuming sulfuric acid.

According to the present invention, the telogen may be any of the existing substances that may play a role in bridging lignin and phenol. For example, the telogen may be aldehyde, preferably C₁-C₆ aldehydes. A concrete example of the C₁-C₆ aldehydes may include without limitation: formaldehyde, acetaldehyde, glyoxal, propanal, butyraldehyde, pentanal and hexanal, preferably formaldehyde and/or acetaldehyde.

According to the present invention, as described above, the reaction is taken at 140-220° C., preferably at 160-180° C. Further, the reaction conditions also include reaction time. Typically, the lengthening of reaction time helps raise the conversion rate of reactants and the yield of reaction products, but too long reaction time does not have an obvious effect to the increase of the conversion rate of reactants and the yield of reaction products. Therefore, after comprehensive consideration of effect and efficiency, the preferred reaction time is 6-10 h.

According to the present invention, the viscosity reduction rate of the dispersant may be selected and varied in a wide range. Preferably, 0.9-1.1 parts by weight of the dispersant can reduce the viscosity of 100 parts by weight of salt water weighted based mud by at least 70% at 25° C. or after aging at 120° C. for 16 h. The salt water weighted based mud contains water, sodium chloride, sodium carbonate, sodium bentonite and barite, and on the basis of 300 mL of water in the salt water weighted based mud, the content of sodium chloride is 12 g, the content of sodium carbonate is 1.2 g, the content of sodium bentonite is 24 g and the content of barite is 980 g.

Wherein, the salt water weighted based mud may be prepared by the following method: Water, sodium chloride, sodium carbonate and sodium bentonite are stirred and mixed evenly and maintained in a bottle with ground stopper for 24 h, and then barite is added, stirred and mixed evenly. If 300 mL of water is chosen as a benchmark, then the content of sodium chloride is 12 g, the content of sodium carbonate is 1.2 g, the content of sodium bentonite is 24 g and the content of barite is 980 g.

In the present invention, the viscosity reduction rate refers to the reduction rate of the readings of a six-speed rotational viscometer measured at 100 r/min before and after adding the dispersant to salt water weighted based mud and high speed stirring at 10000 r/min for 10 min. In other words, viscosity reduction rate (%)=(reading before addition of the dispersant−reading after addition of the dispersant)÷reading before addition of the dispersant 100%.

According to the present invention, to facilitate transport and subsequent preparation of the drilling fluid, it is preferred that the product obtained from the reaction of water, lignin, phenol, sulfonating agent, telogen and catalyst is dried by a method known to those skilled in the art, spray drying for example. Here it is not elaborated further.

The present invention also provides a drilling fluid containing the foregoing dispersant.

According to the present invention, the types of substances contained in the drilling fluid are known to those skilled in the art. For example, in addition to the foregoing dispersant, the drilling fluid further preferably contains one or more selected from the group consisting of externally added and/or non-externally added water, barite, filtration control agent, bentonite, metal chloride, rheology modifier, lubricant, surfactant and pH regulator.

It should be noted that the components in the drilling fluid may contain a certain amount of water. For example, as described above, a certain amount of water needs to be added during preparation of the dispersant and the water may or may not be removed after completion of the preparation, so when the water in the dispersant is not removed, the drilling fluid containing the dispersant contains a certain amount of water. In this case, whether to externally add water or not may be reasonably selected according to the actual situation. When the water in the dispersant has been removed and other components of the drilling fluid do not contain water either, a certain amount of water needs to be added externally in order to meet the need of use. That is to say, the foresaid water content in the present invention refers to total amount of water. Further, in the present invention, removing water or containing no water does not mean absolutely containing no water. It refers to the typically acceptable water content in a product in the art.

According to the present invention, the content of each substance in the drilling fluid may be selected and varied in a large range. For example, on the basis of 100 parts by weight of externally and non-externally added water, the content of the barite may be 450-750 parts by weight, the content of the dispersant may be 2.5-20 parts by weight, the content of the filtration control agent may be 4-20 parts by weight, the content of the bentonite may be 0.25-4 parts by weight, the content of the metal chloride may be 5-25 parts by weight, the content of the rheology modifier may be 1.25-7.5 parts by weight, the content of the lubricant may be 2-8 parts by weight and the content of the surfactant may be 0.25-7 parts by weight. Preferably, on the basis of 100 parts by weight of externally and non-externally added water, the content of the barite is 500-700 parts by weight, the content of the dispersant is 6-16 parts by weight, the content of the filtration control agent is 6-12 parts by weight, the content of the bentonite is 1.5-3 parts by weight, the content of the metal chloride is 5-25 parts by weight, the content of the rheology modifier is 1-4 parts by weight, the content of the lubricant is 3-7 parts by weight and the content of the surfactant is 0.5-5 parts by weight. Further, it is preferred that the content of the pH regulator ensures the pH value of the drilling fluid is 9-11.

According to the present invention, the filtration control agent may be any substance that can reduce filtration loss of the drilling fluid. For example, it may be carboxymethyl cellulose, carboxymethyl starch and other modified natural polymers, or may be sulfomethyl phenolic resin, acrylamide/acrylic acid copolymer and other synthetic polymers. Preferably, the filtration control agent contains the product obtained from the reaction of water, substance containing humic acid and/or modified humic acid, aldehyde and sulfonate polymer at 180-220° C., and the units containing sulfonate groups in the molecular chains of sulfonate polymer are at least 30 wt %, preferably 50-75 wt %, more preferably 60-75 wt %. The content of the units containing sulfonate groups is calculated based on the feeding.

According to the present invention, during preparation of the foregoing filtration control agent, the dosages of water, substance containing humic acid and/or modified humic acid, aldehyde and sulfonate polymer may be selected and varied in a wide range and may be reasonably selected according to the actually needed filtration control agent. Typically, on the basis of 100 parts of water by weight, the dosage of the substance containing humic acid and/or modified humic acid may be 10-70 parts by weight, the dosage of the aldehyde may be 0.5-20 parts by weight and the dosage of the sulfonate polymer may be 2-30 parts by weight. Preferably, on the basis of 100 parts by weight of water, the dosage of the substance containing humic acid and/or modified humic acid is 25-55 parts by weight, the dosage of the aldehyde is 1-10 parts by weight and the dosage of the sulfonate polymer is 5-15 parts by weight. In this way, the filtration loss reduction performance of the obtained filtration control agent, temperature and salt resistance and the caused viscosity increase effect of the drilling fluid can be balanced in a better way.

According to the present invention, the types of the substance containing humic acid and/or modified humic acid are known to those skilled in the art. For example, it may be one or more selected from the group consisting of sulfonated lignite, walchowite, sodium humate, potassium humate, and nitric acid modified humic acid. In order that the obtained filtration control agent has higher resistance to temperature and salt, the preferred substance containing humic acid and/or modified humic acid is sulfonated lignite.

The present invention does not have special limitation to the types of aldehydes used during preparation of the filtration control agent. They may be any types of aldehydes known to those skilled in the art, C₁-C₆ aldehydes for example. A concrete example of the C₁-C₆ aldehydes may include without limitation: formaldehyde, acetaldehyde, glyoxal, propanal, butyraldehyde, pentanal and hexanal, preferably one or more selected from the group consisting of formaldehyde, acetaldehyde and glyoxal.

According to the present invention, the sulfonate polymer may be any existing polymer which contains sulfonate groups and in which the units containing sulfonate groups are at least 30 wt %, preferably 50-75 wt % and more preferably 60-75 wt %. Preferably, the sulfonate polymer has at least one of the structures shown in Formula (I)-Formula (III):

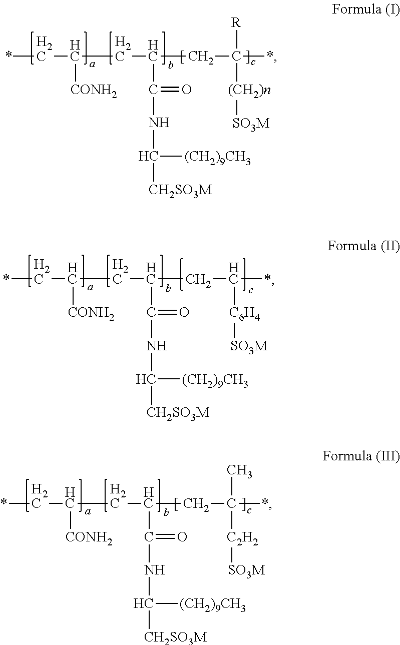

Where, M is Na⁺ or K⁺; R is H or CH₃; n is 0, 1 or 2; b: c=1: 5-60. a, b and c denote the molar numbers of the corresponding structural units.

It should be noted that the foregoing Formula (I)-Formula (III) are only intended to express the types and ratios of the structural units of the polymer and not to express the connection relations of the structural units.

Under the foregoing circumstances, the units containing sulfonate groups are the structural units containing sulfonate groups. For example, as described above, that the units containing sulfonate groups in the molecular chains of the sulfonate polymer are at least 30 wt %, preferably 50-75 wt % and more preferably 60-75 wt % refers to that the percentage of the weight of structural units b and c is at least 30 wt % of the weight of structural units a, b and c, preferably 50-75 wt % and more preferably 60-75 wt %.

According to the present invention, the relative molecular weight of sulfonate polymer may be selected and varied in a wide range and reasonably adjusted according to the actual situation. Preferably, the relative molecular weight of the sulfonate polymer is not greater than 300,000, more preferably 100,000-300,000, wherein the molecular weight of the sulfonate may be determined by for example the PL-GPC220 GPC (gel permeation chromatography) purchased from Polymer Laboratories (PL).

According to the present invention, the sulfonate polymer may be obtained through purchase, or prepared by any method known to those skilled in the art. Preferably, the method for preparing sulfonate polymer may include the following steps:

Under the conditions of solution polymerization of olefins, monomer mixture takes polymerization reaction in a water solution with the existence of an initiator; the monomer mixture contains monomer A, monomer B and monomer C, wherein the structure of monomer A is as shown in Formula (IV), the structure of monomer B is as shown in Formula (V) and the structure of monomer C is any of the structures as shown in Formula (VI)-Formula (VIII). If the total weight of the monomer mixture is chosen as a benchmark, then the total content of monomer B and monomer C is not lower than 30 wt %, preferably 50-75 wt % and more preferably 60-75 wt %.

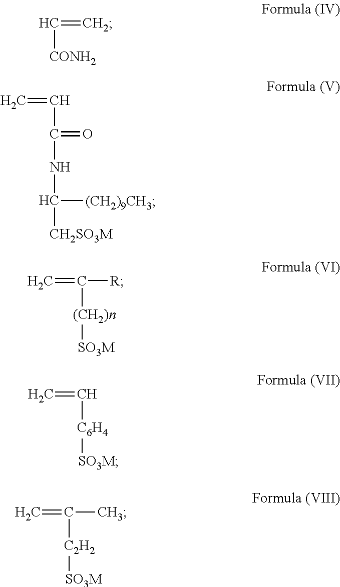

Where, M is Na⁺ or K⁺; R is H or CH₃; n is 0, 1 or 2.

The present invention does not have special limitation to the dosage of the initiator used during preparation of the sulfonate polymer. It may be a conventional selection of the art. Anyway, in consideration of initiation rate and the molecular weight of the polymerization product, preferably, the dosage of the initiator is 1-3% of the total weight of the monomer mixture. The initiator may be one or more selected from the group consisting of the free radical initiators in the art, preferably a redox-type initiator. The redox-type initiator comprises an oxidant and a reductant. The weight ratio between the oxidant and the reductant may be 0.5-2: 1 for example. A concrete example of the oxidant may include without limitation: one or more selected from the group consisting of potassium persulfate, ammonium persulfate and hydrogen peroxide. A concrete example of the reductant may include without limitation: one or more selected from the group consisting of sodium bisulfite, potassium bisulfite, sodium sulfite, potassium sulfite, sodium thiosulfate, tetramethylethylenediamine, ferrous chloride and cuprous chloride.

According to the present invention, during the preparation of the sulfonate polymer, the conditions of polymerization reaction typically may include reaction temperature, reaction time and pH value of the reaction system. For example, the reaction temperature may be 20-95° C., the reaction time may be 2-10 min and the pH value may be 8.5-11. The method to regulate the pH value of the reaction system may be a method known to those skilled in the art. For example, it is regulated through adding an alkaline substance to the reaction system. The alkaline substance for example may be NaOH or KOH. The foregoing alkaline substance may be used directly in form of solid or in form of a water solution. In the latter case, the preferred concentration is 10 wt %˜saturated concentration.

According to the present invention, during the preparation of the sulfonate polymer, in order to control the relative molecular weight of the obtained sulfonate polymer, preferably, the method for preparing sulfonate polymer provided by the present invention also includes adding a molecular weight regulator into the polymerization system during polymerization. The types and dosage of the molecular weight regulator may be the conventional selections of the art. For example, the molecular weight regulator may be a C₃-C₁₂ alcohol compound. A concrete example of C₃-C₁₂ alcohol compound may include without limitation: one or more selected from the group consisting of isopropanol, n-butanol, isobutanol, pentanol, n-hexanol, heptanol, isooctanol, nonanol and tert-dodecyl mercaptan, preferably isopropanol. The dosage of the molecular weight regulator for example may be 0.2-1.0 wt % of the total weight of monomer mixture.

According to the present invention, during the preparation of the sulfonate polymer, water mainly plays the role of a reaction medium. The ratio of the weight of the monomer mixture to the total weight of water and monomer mixture may be selected and varied in a very wide range, for example it may be 0.1-0.4:1.

According to the present invention, preferably, the method for preparing sulfonate polymer also includes shear granulation, drying and pulverizing the obtained polymerization product. The above steps all may be completed by the existing methods. Here they are not elaborated further.

The present invention does not have special limitation to the conditions of the reaction of water, substance containing humic acid and/or modified humic acid, aldehyde and sulfonate polymer. Typically, they may include reaction temperature and reaction time. As described above, the reaction temperature is 180-220° C. Further, the lengthening of reaction time helps raise the conversion rate of reactants and the yield of reaction products, but too long reaction time does not have an obvious effect to the increase of the conversion rate of reactants and the yield of reaction products. Therefore, after comprehensive consideration of effect and efficiency, the preferred reaction time is 6-10 h.

According to the present invention, to facilitate transport and subsequent preparation of the drilling fluid, preferably it also includes drying and pulverizing the product obtained from the reaction of water, substance containing humic acid and/or modified humic acid, aldehyde and sulfonate polymer. The drying and pulverization methods are known to those skilled in the art, spray drying for example. Here it is not elaborated further.

In the drilling fluid of the present invention, the rheology modifier typically may be a low-viscosity polymer obtained from modification of chemical structure of a natural polymer. For example, it may be a modified natural polymer containing one or more selected from the group consisting of sulfonate group, phenolic hydroxyl group and hydroxyl group. This type of rheology modifier can adsorb to the surface of solid particles to break up and weaken the spatial grid structure among particles and assist the dispersant in regulating rheological behavior of an ultra high density drilling fluid system, thereby enabling the dispersant to give better play to its dispersing role. A concrete example of the foregoing modified natural polymer may include without limitation: one or more selected from the group consisting of low-viscosity polyanionic cellulose (LV-PAC), sulfonated tannin and sulfonated tannin extract, which are all available in the market. For example, low-viscosity polyanionic cellulose may be purchased from Puyang Pearl Chemical Co., Ltd. and sulfonated tannin and sulfonated tannin extract may be purchased from Henan Mingtai Chemical Co., Ltd.

According to the present invention, in comprehensive consideration of the density and rheological behavior of the drilling fluid, the preferred density of barite is 4.2-4.3 g/cm³. Further, bentonite may improve the suspension stability of the drilling fluid. The bentonite is a nonmetal mineral product whose main mineral composition is montmorillonite. The bentonite may be sodium bentonite and/or calcium bentonite, preferably sodium bentonite.

According to the present invention, the metal chloride may be any of the existing salt compound formed through combining negative chlorine ions with positive metal ions. For example, it may be one or more selected from the group consisting of potassium chloride, sodium chloride, magnesium chloride, aluminum chloride, calcium chloride, ferric chloride and copper chloride, but in order to raise the ability of the system in inhibiting collapse and to enhance the temperature and salt resistance of the drilling fluid, the preferred metal chloride is potassium chloride and/or sodium chloride.

According to the present invention, the lubricant plays a role in improving the smoothness of the surface of mud cake and meanwhile it also plays a role in inhibiting the internal friction effect of the drilling fluid system, preventing viscosity rise of the system and reducing or eliminating sticking accidents. In an ultra high density drilling fluid, the lubricant shall have a good lubricating effect and meanwhile must not damage the overall performance of the system, for example not have any unfavorable influence to the change of viscosity. The types of the lubricant are known to those skilled in the art. It may be any of the existing lubricants that can be used in a drilling fluid. For example, it may be a solid lubricant or a liquid lubricant. A concrete example of a solid lubricant may include without limitation: graphite, carbon black and glass microspheres. A concrete example of a liquid lubricant may include without limitation: mineral oil, hydrocarbon lubricant and ester lubricant. The hydrocarbon lubricant may be white oil and poly(alpha-olefin). The ester lubricant for example may be butyl stearate or polyethylene glycol ester. The above lubricants are all available in the market.

According to the present invention, the surfactant may be any of the existing surfactants that can be used in a drilling fluid. It may be an ionic surfactant or a nonionic surfactant, preferably a nonionic surfactant, more preferably a dehydrated sorbitan fatty acid ester surfactant. The types of the dehydrated sorbitan fatty acid ester surfactant are known to those skilled in the art and may be any of the existing surfactants obtained from the reaction of sorbitol and fatty acid. For example, it may be dehydrated sorbitan monolaurate (Span 20), dehydrated sorbitan monopalmitate (Span 40), sorbitan monostearate (Span 60), dehydrated sorbitan monooleate (Span 80) or dehydrated sorbitan trioleate (Span 85). Its role is to make the lubricant form a moderate emulsification effect in a drilling fluid system. Thereby the lubricant can be thoroughly and evenly dispersed, raise its ability of lubrication and resistance reduction, and play a role in improving the surface property of barite and promoting its even distribution in the system.

According to the present invention, the pH regulator may also be an existing substance that can regulate the pH value of the drilling fluid to 9-11. For example, it may include one or more selected from the group consisting of sodium hydroxide, potassium hydroxide, sodium carbonate, potassium carbonate, sodium bicarbonate or potassium bicarbonate. The pH regulator may be used in form of solid or a solution. When it is used in form of a solution, its concentration may be 10 wt %˜saturated concentration.

Below the present invention is elaborated in connection with examples.

In the following examples and comparison examples, the raw materials used are as follows:

p-cresol: Beijing Chemical Reagents Company, AR;

Sodium sulfite: Beijing Chemical Works, AR;

Sodium bisulfite: Beijing Yili Fine Chemical Co., Ltd.;

Formaldehyde: Beijing Chemical Reagents Company, AR;

P-toluenesulfonic acid: Zibo Like Fine Chemical Technologies Co., Ltd., industrial product;

Sulfamic acid: Guangzhou Xincheng Trading Co., Ltd., industrial product;

Sodium hydroxide: Beijing Chemical Works, AR;

Sodium chloride: Beijing Chemical Works, AR; Span-80: Xilong Chemical Co., Ltd., CR;

Barite: Guizhou Kaili Longteng Mining Co., Ltd., density 4.32 g/cm³;

White oil: Hebei Xinji Jingshan Petrochemical Plant, industrial product;

Sodium bentonite: The sodium bentonite produced by Boyou Sludge Technologies Co., Ltd. of Shengli Oilfield and used in drilling fluid experiments;

Low-viscosity PAC: Unitechn Co., Ltd., grade LV-PAC, industrial product;

Sulfonated lignite: Dagang Oilfield Group Oilfield Chemical Co., Ltd, grade SMC, industrial product;

Herbal lignin: Langfang Shengxiang Energy-saving Materials Co., Ltd., number-average molecular weight 12,000, industrial product;

Woody lignin: Langfang Shengxiang Energy-saving Materials Co., Ltd., number-average molecular weight 15,000, industrial product.

In the following preparation examples, the molecular weight of the sulfonate polymer may be determined by the PL-GPC220 GPC (gel permeation chromatography) purchased from Polymer Laboratories (PL). The content of units containing sulfonate groups is calculated based on the feeding.

### Preparation Example 1

### (1) Preparation of Sulfonate Polymer

Add 100 mL of water to a reaction bottle, evenly dissolve 50 g (0.70 mol) of water soluble monomers acrylamide, 10 g (0.03 mol) of 2-acrylamide dodecylethane sulfonic acid and 80 g (0.5 μmol) of sodium methylallyl sulfonate in water under stirring, add 0.5 g of molecular weight regulator isopropanol, use 40 wt % NaOH water solution to regulate the pH value of the polymerization system to 9.0, add the water solution of the initiator (1.2 g of ammonium persulfate and 1.2 g of sodium sulfite are dissolved in 5 mL of water respectively) and initiate the reaction at 60° C. It takes 7 min to complete the polymerization and obtains an elastic jelly. After the obtained elastic jelly is pelletized, dried and pulverized, sulfonate polymer PFL-L1 is obtained. The relative molecular weight of the sulfonate polymer PFL-L1 is 273,000. The units containing sulfonate groups in the molecular chains are 64.3 wt %.

### (2) Preparation of the Filtration Control Agent

Evenly mix 28 parts by weight of sulfonated lignite, 2 parts by weight of formaldehyde, 11 parts by weight of sulfonate polymer PFL-L1 and 100 parts by weight of water, take reaction at 200° C. for 6 h, and dry and pulverize the product to obtain filtration control agent SML-4A.

### Preparation Example 2

### (1) Preparation of Sulfonate Polymer

Add 100 mL of water to a reaction bottle, evenly dissolve 40 g (0.56 mol) of water soluble monomers acrylamide, 5 g (0.016 mol) of 2-acrylamide dodecylethane sulfonic acid and 100 g (0.53 mol) of potassium isoprene sulfonate in water under stirring, add 0.5 g of molecular weight regulator isopropanol, use 40 wt % KOH water solution to regulate the pH value of the polymerization system to 10.5, add the water solution of the initiator (1.5 g of hydrogen peroxide and 1.0 g of sodium sulfite are dissolved in 5 mL of water respectively) and initiate the reaction at 63° C. It takes 5 min to complete the polymerization and obtains an elastic jelly. After the obtained elastic jelly is pelletized, dried and pulverized, sulfonate polymer PFL-L2 is obtained. The relative molecular weight of sulfonate polymer PFL-L2 is 218,000. The units containing sulfonate groups in the molecular chains are 72.4 wt %.

### (2) Preparation of Filtration Control Agent

Evenly mix 35 parts by weight of sulfonated lignite, 4 parts by weight of formaldehyde, 8 parts by weight of sulfonate polymer PFL-L2 and 100 parts by weight of water, take reaction at 190° C. for 8 h, and dry and pulverize the product to obtain filtration control agent SML-4B.

### Preparation Example 3

### (1) Preparation of Sulfonate Polymer

Add 100 mL of water to a reaction bottle, evenly dissolve 40 g (0.56 mol) of water soluble monomers acrylamide, 8 g (0.026 mol) of 2-acrylamide dodecylethane sulfonic acid and 80 g (0.5 μmol) of sodium methylallyl sulfonate in water under stirring, add 0.8 g of molecular weight regulator isopropanol, use 40 wt % KOH water solution to regulate the pH value of the polymerization system to 10, add the water solution of the initiator (1.5 g of ammonium persulfate and 1.5 g of sodium sulfite are dissolved in 5 mL of water respectively) and initiate the reaction at 63° C. It takes 6 min to complete the polymerization and obtains an elastic jelly. After the obtained elastic jelly is pelletized, dried and pulverized, sulfonate polymer PFL-L3 is obtained. The relative molecular weight of sulfonate polymer PFL-L3 is 146,000. The units containing sulfonate groups in the molecular chains are 68.8 wt %.

### (2) Preparation of the Filtration Control Agent

Evenly mix 50 parts by weight of sulfonated lignite, 2 parts by weight of acetaldehyde, 11 parts by weight of sulfonate polymer PFL-L3 and 100 parts by weight of water, take reaction at 210° C. for 8 h, and dry and pulverize the product to obtain filtration control agent SML-4C.

### Example 1

Evenly mix 20 parts by weight of herbal lignin, 10 parts by weight of phenol, 8 parts by weight of sodium sulfite, 2 parts by weight of formaldehyde, 2 parts by weight of p-toluenesulfonic acid and 100 parts by weight of water, take reaction at 165° C. for 8 h, and dry the product to obtain dispersant SMS-19A.

Preparation of salt water weighted based mud: Add 12 g of sodium chloride and 1.2 g of anhydrous sodium carbonate in 300 mL of distilled water, stir at a high speed (10000 r/min, the same below) for 5 min, add 24 g of sodium bentonite, stir at high speed for 20 min, maintain them in a bottle with ground stopper for 24 h, add 980 g of barite under stirring at a high speed and stir at a high speed for 10 min to obtain salt water weighted based mud. Use a six-speed rotational viscometer to determine the reading Φ₁₀₀ of the salt water weighted based mud at 100 r/min and determine its density and filtration loss by the method specified in SY/T 5621. The density of salt water weighted based mud should be in the range of 2.40±0.05 g/cm³. The value of Φ₁₀₀ should be in the range of 145±10. The filtration loss at normal temperature (25° C., the same below) and the filtration loss after aging at 120° C. for 16 h should be 120-160 mL.

Determination of viscosity reduction rate and filtration loss: Take four portions of the above salt water weighted based mud (one portion is 1317.2 g). The first portion is a blank sample at normal temperature, and determine the reading at 100 r/min Φ₁₀₀₍₁₎ after 10 min's high speed stirring at 25° C.; add 13 g of dispersant SMS-19A into the second portion of the salt water weighted based mud, determine the reading at 100 r/min Φ₁₀₀₍₂₎ and normal-temperature filtration loss after 10 min's high speed stirring at 25° C.; age the third portion of the salt water weighted based mud at 120° C. for 16 h after 10 min's high-speed stirring, stir at a high speed for 5 min after cooling and determine the reading at 100 r/min Φ₁₀₀₍₃₎, add 13 g of dispersant SMS-19A into the fourth portion of the salt water weighted based mud, age it at 120° C. for 16 h after 10 min's high speed stirring, stir at a high speed 5 min after cooling to room temperature and determine the reading at 100 r/min Φ₁₀₀₍₄₎ and normal-temperature filtration loss. Calculate with the following formula the viscosity reduction rate of salt water weighted based mud at normal temperature (25° C.) and after aging at 120° C./16 h:

$$Normal \text{-} temperature viscosity reduction rate = \frac{{Φ}_{100 ( 1 )} - {Φ}_{100 ( 2 )}}{{Φ}_{100 ( 1 )}} \times 100 \%$$

$$Post \text{-} aging viscosity reduction rate = \frac{{Φ}_{100 ( 3 )} - {Φ}_{100 ( 4 )}}{{Φ}_{100 ( 3 )}} \times 100 \%$$

The results obtained are as shown in Table 1.

Note: In the present invention, salt water weighted based mud refers to the mud before addition of the dispersant and filtration control agent. The salt water weighted mud refers to the mud after addition of the dispersant and filtration control agent.

### Example 2

Evenly mix 18 parts by weight of woody lignin, 10 parts by weight of p-cresol, 8 parts by weight of sodium sulfite, 3 parts by weight of formaldehyde, 1 part by weight of p-toluenesulfonic acid and 100 parts by weight of water, take reaction at 160° C. for 8 h, and dry the product to obtain dispersant SMS-19B. Determine its viscosity reduction rate, density and filtration loss by the method given in example 1. The result is shown in Table 1.

### Example 3

Evenly mix 20 parts by weight of woody lignin, 10 parts by weight of phenol, 10 parts by weight of sodium bisulfite, 4 parts by weight of formaldehyde, 1.5 parts by weight of p-toluenesulfonic acid and 100 parts by weight of water, take reaction at 180° C. for 6 h, and dry the product to obtain dispersant SMS-19C. Determine its viscosity reduction rate, density and filtration loss by the method given in example 1. The result is shown in Table 1.

### Example 4

Evenly mix 25 parts by weight of woody lignin, 8 parts by weight of phenol, 8 parts by weight of sodium sulfite, 4 parts by weight of acetaldehyde, 1 part by weight of sulfamic acid and 100 parts by weight of water, take reaction at 170° C. for 6 h, and dry the product to obtain dispersant SMS-19D. Determine its viscosity reduction rate, density and filtration loss by the method given in example 1. The result is shown in Table 1.

### Example 5

Evenly mix 25 parts by weight of woody lignin, 15 parts by weight of p-cresol, 10 parts by weight of sodium sulfite, 4 parts by weight of formaldehyde, 2.5 parts by weight of sulfamic acid and 100 parts by weight of water, take reaction at 160° C. for 8 h, and dry the product to obtain dispersant SMS-19E. Determine its viscosity reduction rate, density and filtration loss by the method given in example 1. The result is shown in Table 1.

### Comparison Example 1

The performance of the dispersant is tested by the method given in example 1. Differently, the dispersant is substituted by a zwitterionic thinning and dispersing agent (purchased from Xinxiang Zhonghe Resin Co., Ltd., grade XY-27). The result obtained is as shown in Table 1.

TABLE 1

| | | Normal | | After aging at | |
|---|---|---|---|---|---|
| | | temperature (25° C.) | | 120° C. for 16 h | |
| | | Viscosity | | Viscosity | |
| | | reduction | Filtration | reduction | Filtration |
| No. | Density | rate, % | loss, mL | rate, % | loss, mL |
| Example 1 | 2.40 g/cm³ | 86.5 | 4.5 | 81.1 | 11.0 |
| Example 2 | 2.40 g/cm³ | 84.2 | 5.4 | 80.8 | 12.5 |
| Example 3 | 2.40 g/cm³ | 85.4 | 4.5 | 81.0 | 10.3 |
| Example 4 | 2.40 g/cm³ | 84.2 | 4.7 | 81.3 | 13.1 |
| Example 5 | 2.40 g/cm³ | 84.0 | 5.2 | 81.5 | 12.6 |
| Comparison | 2.40 g/cm³ | 43.8 | 141 | 55.1 | 131.2 |
| example 1 | | | | | |

From the result in Table 1, we may know that at normal temperature (25° C.), the dispersant provided by the present invention not only can significantly reduce the viscosity of the salt water weighted mud with a density of 2.40 g/cm³ and the filtration loss of this salt water weighted mud (the filtration loss before addition of the dispersant is 120-160 mL). After aging at 120° C. for 16 h, the viscosity reduction rate is still greater than 80.8% and the filtration loss is low, too. It suggests the dispersant provided by the present invention has a good dispersion effect, can reduce viscosity and filtration loss and is highly resistant to temperature and salt.

### Example 6

Evenly mix 2.36 parts by weight of sodium bentonite and 100 parts by weight of water to obtain sodium bentonite slurry, age it for 24 h, then add 3.09 parts by weight of dispersant SMS-19A, 7.27 parts by weight of filtration control agent SML-4A, 2.18 parts by weight of rheology modifier low-viscosity PAC, 2.73 parts by weight of lubricant white oil, 0.55 part by weight of surfactant Span-80 and 18.2 parts by weight of sodium chloride and 1.27 parts by weight of pH regulator NaOH under stirring, add 349 parts by weight of barite after stirring till thorough dissolution, continue to stir 20 min and then test the pre-aging performance of the drilling fluid. Put the drilling fluid prepared by the above method into a high temperature digestion tank, age it at 120° C. for 16 h, and then cool it to 55° C. and test the post-aging performance of the drilling fluid. The result is as shown in Table 2.

TABLE 2

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre-aging | 2.50 | 127 | 108 | 19 | 8/15 | 10 | 1.8 | 15 |
| post-aging | 2.50 | 89 | 73 | 16 | 7/13 | 9.5 | 2.5 | 13 |

Where:
(1) Density: Determined with a drilling fluid densimeter (purchased from Qingdao Haitongda Special Instruments Co., Ltd.), the same below;
(2) AV is apparent viscosity, obtained through calculation with the following formula, the same below:
$AV = \frac{{Φ}_{600}}{2}$ Where Φ₆₀₀ is the reading of a six-speed rational viscometer at 600 r/min;
(3) PV is plastic viscosity. It is calculated with the following formula, the same below:
PV = Φ₆₀₀ − Φ₃₀₀
Where Φ₆₀₀ is the reading of a six-speed rational viscometer at 600 r/min, and Φ₃₀₀ is the reading of a six-speed rational viscometer at 300 r/min;
(4) YP is yield point. It is calculated with the following formula, the same below:
YP = 0. 48(Φ₃₀₀ − PV)
Where Φ₃₀₀ is the reading of a six-speed rational viscometer at 300 r/min and PV is plastic viscosity;
(5) Initial gel strength refers to the reading of a six-speed rational viscometer at 3 r/min after the drilling fluid is stirred at 600 r/min for l min and rests for 10 s, the same below;
10-minuto gel strength refers to the reading of a six-speed rational viscometer at 3 r/min after the drilling fluid is stirred at 600 r/min for l min and rests for 10 min, the same below;
(6) FL_{API} is the filtration loss determined at 25° C. and 690 KPa, the same below;
(7) FL_{HTHP} is the filtration loss determined at 120° C. and 3450 KPa, the same below;

From the result of Table 2, we may know that the apparent viscosity AV of the drilling fluid which contains the dispersant provided by the present invention and whose density is 2.50 g/cm³ is 89 mPa·s after aging at 120° C. for 16 h, the post-aging filtration loss at low temperature and low pressure FL_{API} is 2.5 mL and the filtration loss at high temperature and high pressure FL_{HTHP} is 13 mL, suggesting its rheological behavior is good and its filtration loss can be easily controlled.

### Example 7

Evenly mix 2.13 parts by weight of sodium bentonite and 100 parts by weight of water to obtain sodium bentonite slurry, age it for 24 h, then add 3.87 parts by weight of dispersant SMS-19A, 8.90 parts by weight of filtration control agent SML-4A, 1.55 parts by weight of rheology modifier low-viscosity PAC, 2.90 parts by weight of lubricant white oil, 0.61 part by weight of surfactant Span-80, 19.3 parts by weight of sodium chloride and 1.31 parts by weight of pH regulator NaOH under stirring, add 418 parts by weight of barite after stirring till thorough dissolution, continue to stir 20 min and then test the pre-aging performance of the drilling fluid. Put the drilling fluid prepared by the above method into a high temperature digestion tank, age it at 120° C. for 16 h, and then cool it to 55° C. and test the post-aging performance of the drilling fluid. The result is as shown in Table 3.

TABLE 3

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre-aging | 2.62 | 121 | 102 | 19 | 10/22 | 10 | 1.0 | 8 |
| post-aging | 2.62 | 92 | 76 | 16 | 9/17 | 9.5 | 1.8 | 9 |

From the result of Table 3, we may know that the apparent viscosity AV of the drilling fluid which contains the dispersant provided by the present invention and whose density is 2.62 g/cm³ is 92 mPa·s after aging at 120° C. for 16 h, the post-aging filtration loss at low temperature and low pressure FL_{API} is 1.8 mL and the filtration loss at high temperature and high pressure FL_{HTHP} is 9 mL, suggesting its rheological behavior is good and its filtration loss can be easily controlled.

### Example 8

Evenly mix 2.3 parts by weight of sodium bentonite and 100 parts by weight of water to obtain sodium bentonite slurry, age it for 24 h, then add 9.3 parts by weight of dispersant SMS-19A, 8.1 parts by weight of filtration control agent SML-4A, 1.8 parts by weight of rheology modifier low-viscosity PAC, 3.5 parts by weight of lubricant white oil, 0.7 part by weight of surfactant Span-80, 23 parts by weight of sodium chloride and 2.1 parts by weight of pH regulator NaOH under stirring, add 523 parts by weight of barite after stirring till thorough dissolution, continue to stir 20 min and then test the pre-aging performance of the drilling fluid. Put the drilling fluid prepared by the above method into a high temperature digestion tank, age it at 120° C. for 16 h, and then cool it to 55° C. and test the post-aging performance of the drilling fluid. The result is as shown in Table 4.

TABLE 4

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre-aging | 2.74 | 141 | 123 | 18 | 10/19 | 10 | 1.5 | 9 |
| post-aging | 2.75 | 99 | 82 | 17 | 9/17.5 | 9.5 | 2.0 | 11 |

From the result of Table 4, we may know that the apparent viscosity AV of the drilling fluid which contains the dispersant provided by the present invention is 99 mPa·s after aging at 120° C. for 16 h, the post-aging filtration loss at low temperature and low pressure FL_{API} is 2.0 mL and the filtration loss at high temperature and high pressure FL_{HTHP} is 11 mL, suggesting its rheological behavior is good and its filtration loss can be easily controlled.

### Example 9

Evenly mix 1.82 parts by weight of sodium bentonite and 100 parts by weight of water to obtain sodium bentonite slurry, age it for 24 h, then add 11.2 parts by weight of dispersant SMS-19A, 8.0 parts by weight of filtration control agent SML-4A, 1.8 parts by weight of rheology modifier low-viscosity PAC, 4.5 parts by weight of lubricant white oil, 2.7 parts by weight of surfactant Span-80, 15 parts by weight of sodium chloride and 1.95 parts by weight of pH regulator NaOH under stirring, add 523 parts by weight of barite after stirring till thorough dissolution, continue to stir 20 min and then test the pre-aging performance of the drilling fluid. Put the drilling fluid prepared by the above method into a high temperature digestion tank, age it at 120° C. for 16 h, and then cool it to 55° C. and test the post-aging performance of the drilling fluid. The result is as shown in Table 5.

TABLE 5

| | Density | Six-speed value | | | | | | pH | FL_{API} | FL_{HTHP} |
|---|---|---|---|---|---|---|---|---|---|---|
| No. | (g/cm³) | Φ₆₀₀ | Φ₃₀₀ | Φ₂₀₀ | Φ₁₀₀ | Φ₆ | Φ₃ | value | (mL) | (mL) |
| pre-aging | 2.86 | — | — | — | — | 109 | 85 | 10 | 1.4 | 9 |
| post-aging | 2.86 | — | 248 | 174 | 99 | 19 | 16 | 9.5 | 1.2 | 9 |

Note:
“—” means undetectable by a six-speed rotational viscometer.

From the result of Table 5, we may know that the viscosity of the drilling fluid with a density of 2.86 g/cm³ is undetectable by a six-speed rotational viscometer at 600 r/min after aging at 120° C. for 16 h and is 248 at 300 r/min, suggesting that the rheological behavior of the system is good. The post-aging filtration loss at low temperature and low pressure FL_{API} is 1.2 mL and the filtration loss at high temperature and high pressure FL_{HTHP} is 9 mL, suggesting its filtration loss can be easily controlled.

### Example 10

Evenly mix 1.6 parts by weight of sodium bentonite and 100 parts by weight of water to obtain sodium bentonite slurry, age it for 24 h, then add 13.2 parts by weight of dispersant SMS-19A, 7.9 parts by weight of filtration control agent SML-4A, 3.4 parts by weight of rheology modifier low-viscosity PAC, 6.6 parts by weight of lubricant white oil, 4.0 parts by weight of surfactant Span-80, 7.9 parts by weight of sodium chloride and 4.0 parts by weight of pH regulator NaOH under stirring, add 547 parts by weight of barite after stirring till thorough dissolution, continue to stir 20 min and then test the pre-aging performance of the drilling fluid. Put the drilling fluid prepared by the above method into a high temperature digestion tank, age it at 120° C. for 16 h, and then cool it to 55° C. and test the post-aging performance of the drilling fluid. The result is as shown in Table 6.

TABLE 6

| | Density | Six-speed value | | | | | | pH | FL_{API} | FL_{HTHP} |
|---|---|---|---|---|---|---|---|---|---|---|
| No. | (g/cm³) | Φ₆₀₀ | Φ₃₀₀ | Φ₂₀₀ | Φ₁₀₀ | Φ₆ | Φ₃ | value | (mL) | (mL) |
| pre-aging | 3.0 | — | — | — | — | 77 | 62 | 10 | 1.0 | 6 |
| post-aging | 3.0 | — | — | 279 | 190 | 84 | 60 | 9.5 | 0.8 | 7 |

Note:
“—” means undetectable by a six-speed rotational viscometer.

From the result of Table 6, we may know that the reading of a six-speed rotational viscometer at 200 r/min is 279 after the drilling fluid with a density of 3.0 g/cm³ is aged at 120° C. for 16 h, suggesting that the rheological behavior of the system is good. The post-aging filtration loss at low temperature and low pressure FL_{API} is 0.8 mL and the filtration loss at high temperature and high pressure FL_{HTHP} is 7 mL, suggesting its filtration loss can be easily controlled.

### Example 11

A drilling fluid is prepared by the method given in example 8 and undergoes an aging test. Differently, the dispersant is replaced with equal parts by weight of the dispersant SMS-19B prepared in example 2. The result obtained is as shown in Table 7.

TABLE 7

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre-aging | 2.75 | — | — | — | — | 10 | 1.9 | 10 |
| post-aging | 2.75 | 124 | 106 | 18 | 10/19 | 9.5 | 2.8 | 14 |

From the result of Table 7, we may know that the apparent viscosity AV of the drilling fluid which contains the dispersant provided by the present invention after aging at 120° C. for 16 h is 124 mPa·s, the post-aging filtration loss at low temperature and low pressure FL_{API} is 2.8 mL and the filtration loss at high temperature and high pressure FL_{HTHP} is 14 mL, suggesting its rheological behavior is good and its filtration loss can be easily controlled.

### Example 12

A drilling fluid is prepared by the method given in example 8 and undergoes an aging test. Differently, the dispersant is replaced with equal parts by weight of the dispersant SMS-19C prepared in example 3. The result obtained is as shown in Table 8.

TABLE 8

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre-aging | 2.75 | 149 | 130 | 19 | 10/20 | 10 | 1.6 | 8 |
| post-aging | 2.75 | 118 | 101 | 17 | 9.5/18 | 9.5 | 2.2 | 11 |

From the result of Table 8, we may know that the apparent viscosity AV of the drilling fluid which contains the dispersant provided by the present invention after aging at 120° C. for 16 h is 118 mPa·s, the post-aging filtration loss at low temperature and low pressure FL_{API} is 2.2 mL and the filtration loss at high temperature and high pressure FL_{HTHP} is 11 mL, suggesting its rheological behavior is good and its filtration loss can be easily controlled.

### Example 13

A drilling fluid is prepared by the method given in example 8 and undergoes an aging test. Differently, the dispersant is replaced with equal parts by weight of the dispersant SMS-19D prepared in example 4 and the filtration control agent is replaced with equal parts by weight of the filtration control agent SML-4B prepared in preparation example 2. The result obtained is as shown in Table 9.

TABLE 9

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre- aging | 2.74 | 146 | 126 | 20 | 11/21 | 10 | 2 | 9.8 |
| post-aging | 2.75 | 108 | 89 | 19 | 10/18 | 9.5 | 2.4 | 10.6 |

From the result of Table 9, we may know that the apparent viscosity AV of the drilling fluid which contains the dispersant provided by the present invention after aging at 120° C. for 16 h is 108 mPa·s, the post-aging filtration loss at low temperature and low pressure FL_{API} is 2.4 mL and the filtration loss at high temperature and high pressure FL_{HTHP} is 10.6 mL, suggesting its rheological behavior is good and its filtration loss can be easily controlled.

### Example 14

A drilling fluid is prepared by the method given in example 8 and undergoes an aging test. Differently, the dispersant is replaced with equal parts by weight of the dispersant SMS-19E prepared in example 5 and the filtration control agent is replaced with equal parts by weight of the filtration control agent SML-4C prepared in preparation example 3. The result obtained is as shown in Table 10.

TABLE 10

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre- aging | 2.75 | 140 | 118 | 22 | 13/24 | 10 | 2.8 | 14 |
| post-aging | 2.75 | 110 | 93 | 17 | 11/20 | 9.5 | 2.4 | 12 |

From the result of Table 10, we may know that the apparent viscosity AV of the drilling fluid which contains the dispersant provided by the present invention after aging at 120° C. for 16 h is 110 mPa·s, the post-aging filtration loss at low temperature and low pressure FL_{API} is 2.4 mL and the filtration loss at high temperature and high pressure FL_{HTHP} is 12 mL, suggesting its rheological behavior is good and its filtration loss can be easily controlled.

### Example 15

A drilling fluid is prepared by the method given in example 8 and undergoes an aging test. Differently, the filtration control agent is replaced with equal parts by weight of the carboxymethyl cellulose (purchased from Zibo Lianji Group Company, grade LV-CMC). The result obtained is as shown in Table 11.

TABLE 11

| | | | | | Initial gel strength/ | | | |
|---|---|---|---|---|---|---|---|---|
| | Density | AV | PV | YP | 10-minuto gel | pH | FL_{API} | FL_{HTHP} |
| No. | (g/cm³) | (mPa · s) | (mPa · s) | (Pa) | strength (Pa) | value | (mL) | (mL) |
| pre-aging | 2.73 | — | — | — | — | 10 | 5.6 | 18 |
| post-aging | 2.75 | 138 | 110 | 28 | 17/32 | 9.5 | 4.2 | 22 |

From the result of Table 11, we may know that the apparent viscosity AV of the drilling fluid which contains the dispersant provided by the present invention after aging at 120° C. for 16 h is 138 mPa·s, the post-aging filtration loss at low temperature and low pressure FL_{API} is 4.2 mL and the filtration loss at high temperature and high pressure FL_{HTHP} is 22 mL, suggesting its rheological behavior is good and its filtration loss can be easily controlled.

### Comparison Example 2

A drilling fluid is prepared by the method given in example 15 and undergoes an aging test. Differently, the dispersant SMS-19A is replaced with equal parts by weight of a zwitterionic polymer thinning and dispersing agent (manufactured by Xinxiang Zhonghe Resin Co., Ltd., grade XY-27). The result obtained is as shown in Table 12.

TABLE 12

| | Density | Six-speed value | | | | | | pH | FL_{API} | FL_{HTHP} |
|---|---|---|---|---|---|---|---|---|---|---|
| No. | (g/cm³) | Φ₆₀₀ | Φ₃₀₀ | Φ₂₀₀ | Φ₁₀₀ | Φ₆ | Φ₃ | value | (mL) | (mL) |
| pre- aging | 2.74 | — | — | 210 | 109 | 54 | 42 | 10 | 6 | 28 |
| post-aging | 2.75 | — | 254 | 178 | 91 | 47 | 31 | 9.5 | 7 | 37 |

From the result in Table 12, we may know that Φ₃₀₀ of the drilling fluid obtained after the dispersant provided by the present invention is replaced with equal parts by weight of zwitterionic polymer thinner XY-27 is 254 after aging at 120° C. for 16 h, the post-aging filtration loss at low temperature and low pressure FL_{API} is 7 mL and the filtration loss at high temperature and high pressure FL_{HTHP} is 37 mL, suggesting its rheological behavior is poor and its filtration loss can not be easily controlled.

From the result of the foregoing examples, we may know the dispersant provided by the present invention not only can significantly reduce the viscosity of the drilling fluid but also plays a role in reducing filtration loss. From the comparison between example 6 and example 15, we may know that the preferred filtration control agent in the present invention also enables the drilling fluid to have more excellent performance in reducing filtration loss and meet the requirements of the drilling of deep wells, ultra-deep wells and ultra high pressure formations.

The preferred embodiments of the present invention are elaborated above, but the present invention is not limited to the concrete details in the foregoing embodiments. Within the range of the technical conception of the present invention, simple modifications to the technical solutions of the present invention are allowed. These simple modifications are all in the protective range of the present invention.

Further, it should be noted that the concrete technical characteristics described in the foregoing embodiments may be combined in any appropriate way provided that there is no contradiction. To avoid unnecessary repetition, the possible ways of combination of the present invention are not further described.

Further, the embodiments of the present invention can be combined freely. Provided that it is not against the conception of the present invention, it shall be deemed as the content disclosed by the present invention.

1. A dispersant comprising the product obtained from the reaction of water, lignin, phenol, sulfonating agent, telogen and catalyst at 140-220° C., preferably at 160-180° C.; the catalyst is one or more selected from the group consisting of sulfamic acid, p-toluenesulfonic acid and benzenesulfonic acid.

2. The dispersant according to claim 1, wherein on the basis of 100 parts by weight of water, the dosage of lignin is 10-40 parts by weight, the dosage of phenol is 1.5-20 parts by weight, the dosage of sulfonating agent is 2.5-15 parts by weight, the dosage of telogen is 0.5-5 parts by weight and the dosage of the catalyst is 0.5-4 parts by weight.

3. The dispersant according to claim 2, wherein on the basis of 100 parts by weight of water, the dosage of lignin is 15-30 parts by weight, the dosage of phenol is 4-15 parts by weight, the dosage of sulfonating agent is 5-10 parts by weight, the dosage of telogen is 1-4 parts by weight and the dosage of the catalyst is 0.8-2 parts by weight.

4. The dispersant according to claim 1, wherein the phenol may be one or more selected from the group consisting of phenol, p-cresol and m-cresol.

5. The dispersant according to claim 1, wherein the sulfonating agent is one or more selected from the group consisting of sodium sulfite, potassium sulfite, sodium bisulfite, potassium bisulfite and sulfuric acid.

6. The dispersant according to claim 1, wherein the telogen is aldehyde, preferably formaldehyde and/or acetaldehyde.

7. The dispersant according to claim 1, wherein the reaction time is 6-10 h.

8. The dispersant according to claim 1, wherein 0.9-1.1 parts by weight of the dispersant can reduce the viscosity of 100 parts by weight of salt water weighted based mud by at least 70% at 25° C. or after aging at 120° C. for 16 h; the salt water weighted based mud contains water, sodium chloride, sodium carbonate, sodium bentonite and barite; and on the basis of 300 mL of water in the salt water weighted based mud, the content of sodium chloride is 12 g, the content of sodium carbonate is 1.2 g, the content of sodium bentonite is 24 g and the content of barite is 980 g.

9. A drilling fluid containing the dispersant according to claim 1.

10. The drilling fluid according to claim 9, wherein the drilling fluid further contains one or more selected from the group consisting of externally added and/or non-externally added water, barite, filtration control agent, bentonite, metal chloride, rheology modifier, lubricant, surfactant and pH regulator.

11. The drilling fluid according to claim 10, wherein in the drilling fluid, on the basis of 100 parts by weight of externally and non-externally added water, the content of the barite is 450-750 parts by weight, the content of the dispersant is 2.5-20 parts by weight, the content of the filtration control agent is 4-20 parts by weight, the content of the bentonite is 0.25-4 parts by weight, the content of the metal chloride is 5-25 parts by weight, the content of the rheology modifier is 1.25-7.5 parts by weight, the content of the lubricant is 2-8 parts by weight and the content of the surfactant is 0.25-7 parts by weight.

12. The drilling fluid according to claim 11, wherein on the basis of 100 parts by weight of externally and non-externally added water, the content of the barite is 500-700 parts by weight, the content of the dispersant is 6-16 parts by weight, the content of the filtration control agent is 6-12 parts by weight, the content of the bentonite is 1.5-3 parts by weight, the content of the metal chloride is 5-25 parts by weight, the content of the rheology modifier is 1-4 parts by weight, the content of the lubricant is 3-7 parts by weight and the content of the surfactant is 0.5-5 parts by weight; preferably, the content of the pH regulator ensures the pH value of the drilling fluid is 9-11.

13. The drilling fluid according to claim 10, wherein the filtration control agent contains the product obtained from the reaction of water, substance containing humic acid and/or modified humic acid, aldehyde and sulfonate polymer at 180-220° C., and the units containing sulfonate groups in the molecular chains of sulfonate polymer are at least 30 wt %, preferably 50-75 wt %, more preferably 60-75 wt %.

14. The drilling fluid according to claim 13, wherein in the reaction for preparation of the filtration control agent, on the basis of 100 parts by weight of water, the dosage of the substance containing humic acid and/or modified humic acid is 10-70 parts by weight, the dosage of the aldehyde is 0.5-20 parts by weight and the dosage of the sulfonate polymer is 2-30 parts by weight.

15. The drilling fluid according to claim 14, wherein on the basis of 100 parts by weight of water, the dosage of the substance containing humic acid and/or modified humic acid is 25-55 parts by weight, the dosage of the aldehyde is 1-10 parts by weight and the dosage of the sulfonate polymer is 5-15 parts by weight.

16. The drilling fluid according to claim 13, wherein the substance containing humic acid and/or modified humic acid is one or more selected from the group consisting of sulfonated lignite, walchowite, sodium humate, potassium humate and nitric acid modified humic acid; preferably, the aldehyde for preparing the filtration control agent is one or more selected from the group consisting of formaldehyde, acetaldehyde and glyoxal.

17. The drilling fluid according to claim 13, wherein the relative molecular weight of the sulfonate polymer is not greater than 300,000, preferably 100,000˜300,000; preferably, the sulfonate polymer has at least one of the structures shown in Formula (I)-Formula (III): 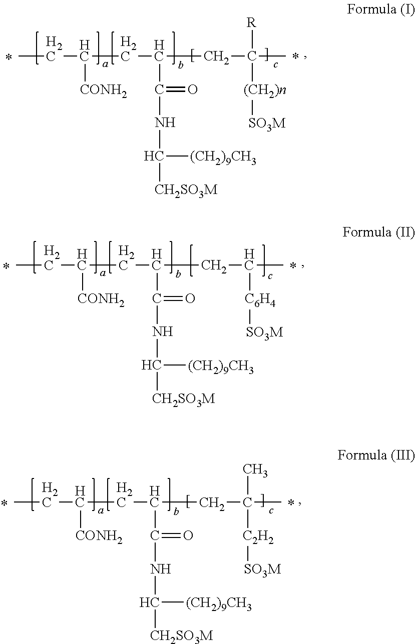
Where M is Na⁺ or K⁺; R is H or CH₃; n is 0, 1 or 2; b: c=1: 5-60.

18. The drilling fluid according to claim 13, wherein the time of the reaction of water, substance containing humic acid and/or modified humic acid, aldehyde and sulfonate polymer is 6-10 h.

19. The drilling fluid according to claim 10, wherein the rheology modifier is a modified natural polymer containing one or more selected from the group consisting of sulfonate group, phenolic hydroxyl group and hydroxyl group; preferably, the modified natural polymer is one or more selected from the group consisting of low-viscosity polyanionic cellulose, sulfonated tannin and sulfonated tannin extract.

20. The drilling fluid according to claim 10, wherein the density of the barite is 4.2-4.3 g/cm³; preferably, the bentonite is sodium bentonite; preferably, the metal chloride is potassium chloride and/or sodium chloride; preferably, the lubricant is one or more selected from the group consisting of mineral oil, hydrocarbon lubricant and ester lubricant; preferably, the surfactant is a dehydrated sorbitan fatty acid ester surfactant; preferably, the pH regulator is one or more selected from the group consisting of sodium hydroxide, potassium hydroxide, sodium carbonate, potassium carbonate, sodium bicarbonate and potassium bicarbonate.
